(19) United States
(12) Patent Application Publication
(10) Pub. No.: US 2004/0172846 A1
(43) Pub. Date: Sep. 9, 2004

(54) Combination rafter square, tape measure, and level

(76) Inventor: Gregory McRae, Lower Lake, CA (US)

Correspondence Address: JOHNSON & STAINBROOK, LLP, 3558 ROUND BARN BLVD., SUITE 203, SANTA ROSA, CA, 95403, US

(21) Appl. No.: 10/794,108

(22) Filed: Mar. 3, 2004

Related U.S. Application Data
(60) Provisional application No. 60/451,638, filed on Mar. 3, 2003.

(51) Int. Cl. G01B 3/10

(52) U.S. Cl. 33/760

(57) ABSTRACT

A combination hand tool for carpenters, including a housing formed of first and second triangular rafter square plates, a side, a base, and a hypotenuse. A tape measure is captured between the rafter square plates and has an extendable/retractable tape with a hook disposed in a side of the housing. At least one level bubble is positioned in the housing and may be viewed through at least one of the rafter square plates.

### CROSS REFERENCE TO RELATED APPLICATIONS

The present application claims the benefit of the filing date of U.S. Provisional Patent Application, Ser. No. 60/451,638, filed Mar. 3, 2003 (Mar. 3, 2003).

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to hand tools for carpentry, and more particularly to a combination rafter square, tape measure, and level.

### BACKGROUND INFORMATION AND DISCUSSION OF RELATED ART

Combination hand tools are well known in the art. Myriad combination hand tools have been designed and developed to simply and shorten the time required to complete multiple sequentially ordered tasks by providing a tool adapted to perform all of the tasks one at a time, or perhaps to perform the tasks simultaneously. The art is thus crowded with clever devices directed to numerous objectives. Exemplary devices in the pertinent art are shown in the following U.S. patents:

U.S. Pat. No. 5,894,675, to Cerricola, teaches a combination tool including a housing which encases a tape measure having an extendable and retractable tape and adapted to encase a laser source capable of projecting a visible light beam. The tape extends from the housing and the visible light beam projects from the housing perpendicular to the extended tape. A horizontal bubble-leveling vial and a vertical bubble-leveling vial are mounted on the housing for leveling in horizontal and vertical planes.

U.S. Pat. No. 5,253,426 to Mosbrucker, discloses a layout square designed to relate the dimensions of the square's legs to the standard width and thickness dimensions of lumber so that joints may be readily laid out. The device includes an integral leveling device to allow for angular measurement, measurement for plumbing studs and leveling beams, layout of rafters without the need of other tools, and simultaneous measurement of angular dimensions of rafters and lay out of other roof members. The apparatus includes a handle to which two legs are attached, all of which are elongate and generally rectangular. The longitudinal axes of the legs are disposed perpendicular to the longitudinal axis of the handle and extend from the handle in the same direction and in the same plane. One leg has linear measurement marks and holes selectively disposed at predetermined, regular intervals for receiving a marker. The handle is thicker than the legs to facilitate placement against a board edge.

U.S. Pat. No. 5,077,910 to Smith shows a combination tool including a carpenter's flat-faced square having conventional first and second legs, the second integrally and immovably and rigidly extending from the lower end of the first and disposed perpendicular to the first in the same plane. A tape measure and mechanism including an extendable and retractable tape is rigidly and immovably mounted on and integral with one of the first and second legs. The tape measure structure and mechanism includes a tape guide structure having marker structure(s), including at least one marker point, positioned to indicate the actual measured-distance between the extendable end and the upright straight edge.

U.S. Design Pat. No. D422,225, to DeGangi et al, discloses a combination rafter square with level

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention is a combination rafter square, tape measure, and level.

It is an object of the present invention to provide a new and improved combination carpenter's hand tool providing means to simplify and streamline the work of measuring, laying out, and marking material and structural members for roof construction.

It is another object of the present invention to provide a new and improved combination carpenter's hand tool that eliminates the need to carry multiple individual tools.

A further object or feature of the present invention is a new and improved carpenter's hand tool that combines a rafter's square, tape measure, and level.

An even further object of the present invention is to provide a novel combination tool that integrates the process of leveling with the processes of measuring and marking roofing materials and structures.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trade-mark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of the combination rafter square, tape measure, and level of the present invention;

FIG. 2 is a side view in elevation of the tool of FIG. 1;

FIG. 3 is an end view of the tool of FIGS. 1 and 2;

FIG. 4A is a view in elevation of the hypotenuse side of the inventive apparatus; and

FIG. 4B is an alternative end view in elevation of the hypotenuse side of the inventive apparatus.

### DRAWING REFERENCE NUMERALS

10 combination rafter square, tape measure, and level generally

12 housing

14 first rafter square plate

16 second rafter square plate

18 side (of housing)

20 base (of housing)

22 hypotenuse (of housing)

24 marked dimensional indicia on rafter square plates proximate hypotenuse

26 marked dimensional indicia proximate the side

28a marked dimensional indicia indicating degrees for hip and valley cuts

28b marked dimensional indicia indicating measurements for common cuts

30 first level bubble

32 second level bubble

34 tape measure

36 tape measure casing

38 end hook of the tape measure

40 extendable/retractable tape

42 outside opening in the side of the housing

44 tape lock

46 pencil holder

### DETAILED DESCRIPTION OF THE INVENTION

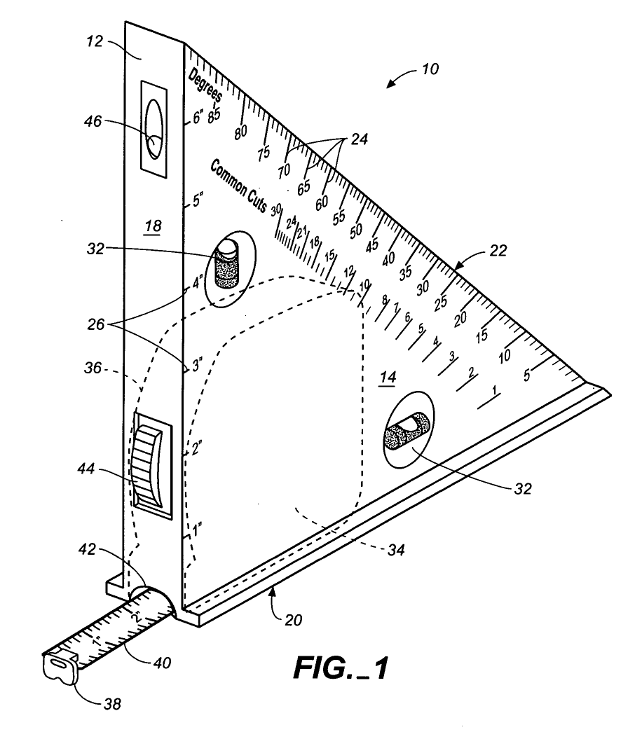

Referring to FIGS. 1 through 4B, wherein like reference numerals refer to like components in the various views, there is illustrated therein a new and improved combination hand tool, including a rafter's square, tape measure, and level, the combination apparatus generally denominated 10 herein.

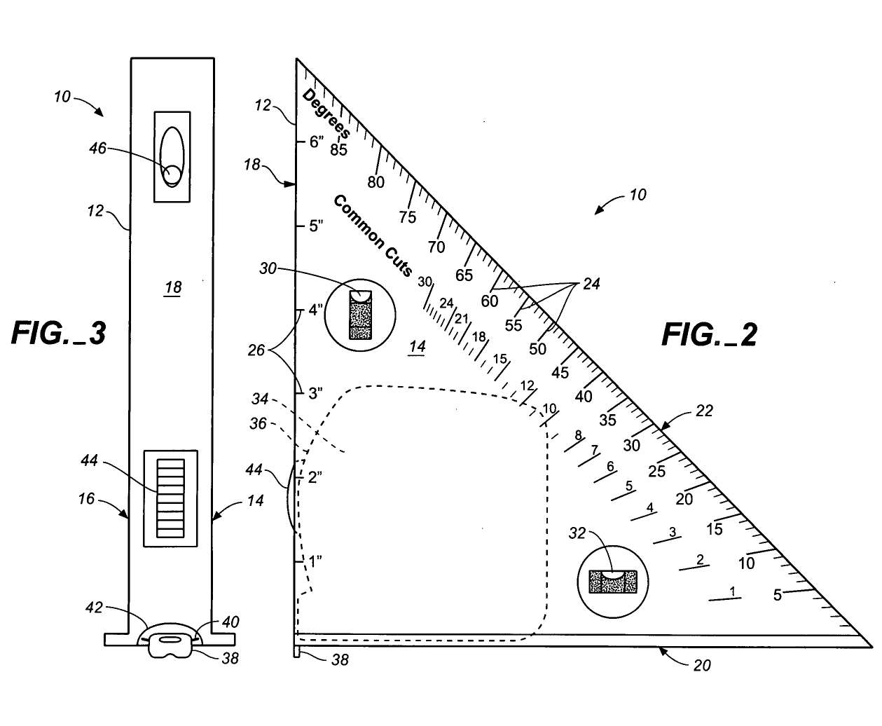

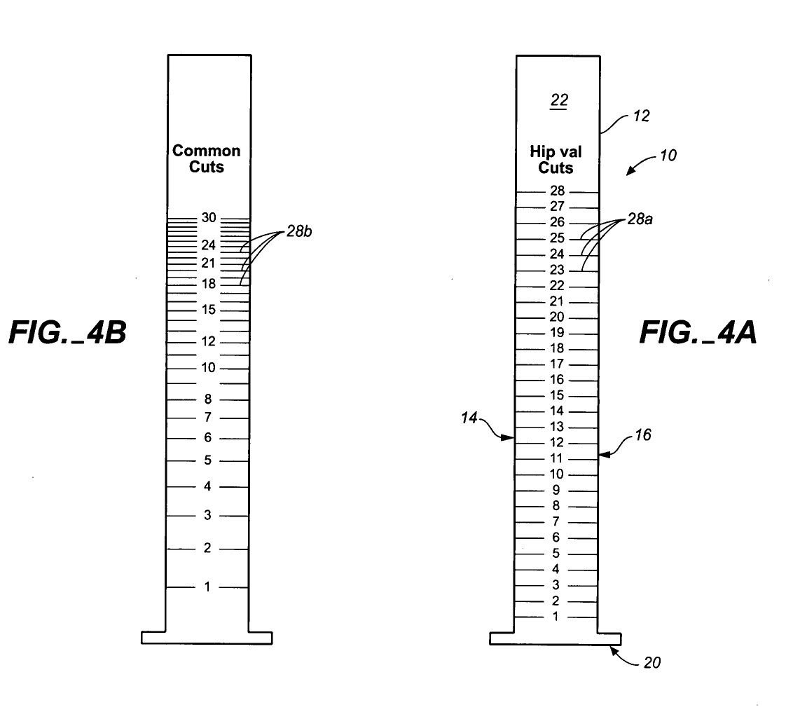

FIG. 1 is perspective view of the combination rafter square, tape measure, and level of the present invention, while FIGS. 2 and 3 are front and side views in elevation thereof. FIG. 4 is a view in elevation of the hypotenuse side of the inventive apparatus shown marked with measurement indicia for making markings for hip and valley cuts; and FIG. 4B is a side view of the hypotenuse side of the apparatus with alternative measurement indicia and markings for common cuts.

Collectively, these views show that the inventive apparatus is a combination rafter square, tape measure, and level 10, said apparatus comprising: a housing 12 having first and second triangular rafter square plates, 14, 16 forming, respectively, the front and back of the housing; a side 18; a base 20, having substantially the same length of side 18 and which is perpendicular to the side; and a hypotenuse 22 extending between points proximate the non-intersecting ends of the side and the base. These elements form the body of the housing and define an open interior space.

Each rafter square plate includes marked dimensional indicia 24 proximate the hypotenuse side 22, which markings include lines and numerals representing angular units of measure in degrees and, optionally, numeral representing roof pitches. Each rafter square further includes marked dimensional indicia 26 proximate the side 18, which markings include lines and numerals representing units of measure in either imperial or metric units or both. Marked dimensional indicia on the hypotenuse side 22 may include degrees for hip and valley cuts 28a [FIG. 4A] or for common cuts 28b, though it is to be understood that other suitable markings may be included depending on the anticipated environment of use.

Preferably the inventive tool also includes one or more level bubbles, including first and second level bubbles, 30, 32, disposed at right angles relative to one another, and viewable through at least one of the rafter plates, and preferably both. Accordingly, the levels provide means to employ the tool to measure and take levels on either vertical or horizontal surfaces.

The novel apparatus notably includes a conventional extendable and retractable tape measure 34 apparatus, preferably enclosed in a selectively or permanently closed casing 36. The tape measure is interposed between the first and second rafter square plates 14 and 16. The tape measure may be permanently affixed within the casing or, more preferably, removably captured in the casing with retention means, such as tensioning clips. The end hook 38 of the extendable/retractable tape 40 is disposed outside opening 42 in side 18 proximate the intersection of the base and the side. The tape measure preferably includes a tape lock 44, preferably disposed in side 18. The tape measure can be installed at the time of manufacture or, as may be preferable for workmen in the trades, can be installed and replaced as the tape measure ages and wears. In this manner, the principal advantages of the design need not be lost when the most vulnerable operational elements are worn out through repeated use or damaged in mishaps.

Finally, the housing 12 may include a pencil holder 46, thereby providing the final tool in the trinity of tools most frequently used by carpenters when measuring for cuts.

Manufacture and assembly are straightforward and elementary. In a first preferred embodiment, rafter square plates 14 and 16 are discrete units which each have holes adapted for screws (not shown) to pass through and engage the opposing plate. The plates are assembled to create the triangular box comprising the apparatus with the tape measure encased inside. Preferably, the housing includes opposing tensioning clips installed on the interior surface of one or both of the rafter square plates to releasably capture a tape measure. Accordingly, tape measures can be installed and removed easily simply by unscrewing the plates to exposure the means for capturing the tape measure.

In an alternative embodiment, one or both of the plates may be provided with a permanent opening adapted for accommodating one or more well-known brands of tape measure. The opposing plate is then equipped with tensioning clips or other suitable retention means (not shown) for releasably capturing the tape measure. The tape measure could then be installed simply by inserting through the opening and into the tensioning clips or other means for securely holding the tape measure within the rafter square housing. In this manner, tapes could be easily replaced without disassembly, and the units could be sold without tapes installed so that the consumer could use tapes already owned and tapes of his or her preference.

As will be readily appreciated, the inventive apparatus eliminates several movements required when measuring in the field. When a carpenter wears a tool belt, the movements eliminated include reaching for and retrieving a measuring tape from a pouch in the belt, and replacing the tape to the pouch. As trivial as the movement is in concept and description, when performed repeatedly over the course of a work period, it consumes a substantial amount of time and energy and subjects the carpenter to risk of repetitive motion injury. The inventive apparatus is thus a tool that promotes economy, convenience, health and safety.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A carpenter's hand tool, comprising, in combination:
a rafter's square;
a tape measure; and
at least one level bubble.

2. A combination hand tool for carpenters, comprising:
a housing including first and second triangular rafter square plates, a side, a base intersecting said side at an end of said base,.and a hypotenuse extending between points proximate the non-intersecting ends of said side and said base;
a tape measure disposed in said housing and including an extendable and retractable tape having a tape hook disposed in said side of said housing; and
at least one level bubble disposed in said housing and viewable through at least one of said rafter square plates.

3. The combination tool of claim 2, wherein said base has substantially the same length as said side and which is perpendicular to said side.

4. The combination tool of claim 2, wherein said housing defines an open interior space.

5. The combination tool of claim 2, wherein at least one of said rafter square plates includes marked dimensional indicia proximate said hypotenuse.

6. The combination tool of claim 5, wherein said marked dimensional indicia on said rafter square plate(s) proximate said hypotenuse includes lines and numerals representing angular units of measure in degrees.

7. The combination tool of claim 5, wherein said marked dimensional indicia on said rafter square plate(s) proximate said hypotenuse includes lines and numerals representing roof pitches.

8. The combination tool of claim 5, wherein said marked dimensional indicia on said rafter square plate(s) proximate said hypotenuse includes lines and numerals representing both angular units of measure in degrees and roof pitches.

9. The combination tool of claim 5, wherein at least one of said rafter square plates further includes marked dimensional indicia proximate said side.

10. The combination tool of claim 5, wherein said markings on said rafter square plate(s) proximate said side include lines and numerals representing units of measure in either imperial or metric units or both.

11. The combination hand tool of claim 2, wherein said hypotenuse includes marked dimensional indicia.

12. The combination hand tool of claim 11, wherein said marked dimensional indicia on said hypotenuse include degrees for hip and valley cuts.

13. The combination hand tool of claim 11, wherein said marked dimensional indicia on said hypotenuse include lines and numerals representing measurements for common cuts.

14. The combination hand tool of claim 11, wherein said marked dimensional indicia on said hypotenuse include lines and numerals representing degrees for hip and valley cuts and measurements for common cuts.

15. The combination hand tool of claim 2, including first and second level bubbles, said bubbles disposed at right angles to one another.

16. The combination hand tool of claim 2, wherein said housing includes retention means for removably capturing said tape measure is removably captured between said first and second rafter square plates.

17. The combination hand tool of claim 2, wherein said wherein said tape measure includes a tape lock disposed in said side.

18. The combination hand tool of claim 2, further including a pencil holder disposed in said housing.
